(19) United States
(12) Patent Application Publication
(10) Pub. No.: US 2018/0225147 A1
(43) Pub. Date: Aug. 9, 2018

(54) RESOURCE ALLOCATION METHOD AND APPARATUS

(71) Applicant: ALIBABA GROUP HOLDING LIMITED, George Town (KY)

(72) Inventors: Guangzhou ZHANG, Beijing (CN); Xiaojian FAN, Hangzhou (CN)

(21) Appl. No.: 15/891,292

(22) Filed: Feb. 7, 2018

(30) Foreign Application Priority Data
Feb. 8, 2017 (CN) 201710069369.1

(51) Int. Cl. G06F 9/50

(52) U.S. Cl. CPC G06F 9/50

(57) ABSTRACT

Resource allocation methods and apparatuses are provided, for dynamically allocating resources to multiple processing units that share resources in a same resource allocation unit. One exemplary resource allocation process comprises: determining amounts of data stored on the multiple processing units; and allocating resources to the multiple processing units according to the amounts of data stored on the multiple processing units, more resources being allocated to a processing unit that stores a larger amount of data. The present application can make fuller use of resources.

### CROSS REFERENCE TO RELATED APPLICATION

This application claims priority to Chinese Application No. 201710069369.1, filed on Feb. 8, 2017, the entirety of which is incorporated herein by reference.

### TECHNICAL FIELD

The present application generally relates to computer technologies, and more specifically, to resource allocation methods and apparatuses.

### BACKGROUND

Resource allocation is important for a system having multiple processing nodes. Conventional resource allocation in related technology usually allocates resources to the multiple processing nodes in an approximately equal manner, or allocating resources according to workloads of the multiple processing nodes. However, such resource allocation methods cannot fully and effectively utilize resources.

For example, in a distributed database system as shown in FIG. 1, the system includes one master node and multiple sub-nodes. The master node stores metadata, and the sub-nodes are responsible for data storage and computing. A sub-node can be one or more operating system processes that are started independently, and can be allocated resources such as disk storage space, disk transmission bandwidth, memory, processors, and network bandwidth.

Multiple sub-nodes may run on the same machine and share the resources of the machine. If there are other application programs running on the machine, the resources shared by the multiple sub-nodes need to be restricted. That is, resource isolation may be required. When shared resources are allocated to the multiple sub-nodes, a common practice is to allocate fixed types and amounts of resources to each sub-node. For example, each sub-node is allocated 8 G memory, 2 Mbps network bandwidth, and the like.

Based on research and analysis, it is found that resources required by a sub-node during operation relates to an amount of data stored thereon. A larger amount of data requires more resources. However, using the existing resource allocation methods, resources are allocated in a fixed manner. If data is unevenly distributed on the sub-nodes, a sub-node storing a relatively large amount of data may not have sufficient resources, while resources of other sub-nodes may not be fully utilized. Taking memory as an example, a node may store 60 G data thereon while other nodes each store 40 G. With the existing methods, all nodes may be allocated approximately the same amount of memory resource. The node having 60 G data actually requires more memory, but is allocated the same memory as other nodes. The nodes having 40 G data require less memory, and may not fully use the allocated memory.

Such a relationship between the resource required by a processing node and the amount of data stored thereon also exists in other systems such as a query system and a service system. Similarly, in these systems, due to the above-described problems, resources may not be fully and effectively utilized using the existing resource allocation methods.

### SUMMARY

According to some embodiments of the present application, resource allocation methods for allocating resources to multiple processing units that share resources in a same resource allocation unit are provided. One resource allocation method includes determining amounts of data stored on the multiple processing units; and allocating resources to the multiple processing units according to the amounts of data stored on the multiple processing units, more resources being allocated to a processing unit that stores a larger amount of data.

According to some embodiments of the present application, resource allocation apparatuses are provided. One resource allocation apparatus comprises a resource allocation module configured to allocate resources to multiple processing units that share resources in a same resource allocation unit. According to some embodiments, the resource allocation module includes a determination unit configured to determine amounts of data stored on the multiple processing units; and an allocation unit configured to allocate resources to the multiple processing units according to the amounts of data stored on the multiple processing units, more resources being allocated to a processing unit that stores a larger amount of data.

According to some embodiments of the present application, resource allocation apparatuses are provided. One resource allocation apparatus comprises a memory and a processor, wherein the memory is configured to store program code; and the processor is configured to execute the program code to perforin the following processing: allocating resources to multiple processing units that share resources in a same resource allocation unit. One resource allocation process includes: determining amounts of data stored on the multiple processing units; and allocating resources to the multiple processing units according to the amounts of data stored on the multiple processing units, more resources being allocated to a processing unit that stores a larger amount of data.

The foregoing resource allocation solutions according to the embodiments of the present application can make fuller use of resources.

### BRIEF DESCRIPTION OF THE DRAWINGS

FIG. 1 is an architectural diagram of an exemplary distributed database system;

FIG. 2 is a flowchart of an exemplary resource allocation method according to some embodiments of the present application;

FIG. 3 is a schematic diagram of an exemplary sub-node grouping of a distributed database system according to some embodiments of the present application; and

FIG. 4 is a modular diagram of an exemplary resource allocation apparatus according to some embodiments of the present application.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods according to some embodiments of the present disclosure, the scope of which is defined by the appended claims.

According to some embodiments of the present application, resource allocation methods are provided. The resource allocation methods can be used for dynamically allocating resources to multiple processing units that share resources in a same resource allocation unit. The resource allocation unit herein can be a hardware or software entity that can allocate resources, such as a physical machine or a virtual machine, a resource group in a machine, or may be a system that uniformly allocates resources to multiple machines. The processing unit described herein can be any unit that can store and process data. The following description is provided, as an example, in the context of multiple sub-nodes of a distributed database system that are located on a same physical machine or virtual machine.

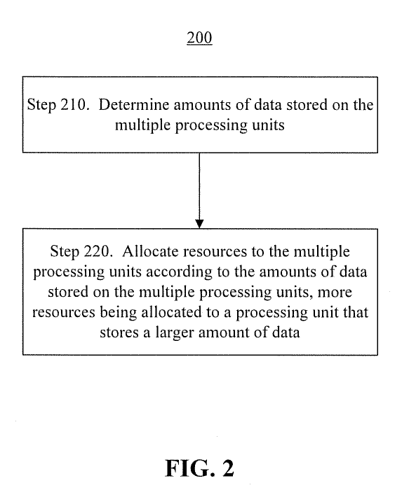

As shown in FIG. 2, according to some embodiments, one resource allocation process 200 of the resource allocation method comprises the following:

In step 210, amounts of data stored on the multiple processing units are determined. The amount of data stored on a processing unit (an amount of data actually stored rather than allocated disk space) may be obtained by using an operating system to monitor an amount of data stored in a disk space allocated to the processing unit. In some embodiments, it may be obtained according to statistics on data amount changes caused by writing, deleting, and other operations on the processing unit. Such statistics may be provided by a system to which the processing unit belongs.

In step 220, resources are allocated to the multiple processing units according to the amounts of data stored on the multiple processing units. More resources are allocated to a processing unit that stores a larger amount of data.

In some embodiments, the allocated resources can include one or more of the following: memory, processors, network bandwidth, disk transmission bandwidth, and temporary disk space. Among the resources, in some embodiments, only some types of the resources may be allocated according to the amounts of stored data, while other types of resources can be allocated in another manner such as allocating according to a predetermined value.

In some embodiments, there may be different methods of allocating more resources to a processing unit that stores a larger amount of data. For example, the resources allocated to the multiple processing nodes can be in direct proportion to the amounts of data stored on the multiple processing units. Direct proportion does not necessarily require that the measurement of precision is the smallest resource unit. The allocation may also be adjusted according to a set minimum resource allocation unit. For example, when allocable memory space is 10M, if a ratio of amounts of data stored on two processing nodes, for example, a processing node A and a processing node B, is 1:2, and memory is allocated based on a minimum unit of 1M, then 3M memory may be allocated to processing node A and 7M memory may be allocated to processing node B. In some embodiments, allocation may also be performed according to a pre-set correspondence relationship between an amount of stored data and a memory capacity. For example, the allocable disk space is 1000, and a memory capacity is 1 G. If an amount of data stored on a processing node ranges from 0 to 10 G, a correspondingly allocated memory capacity is 100M. If an amount of stored data ranges from 10 G to 20 G, a correspondingly allocated memory capacity is 200M, and so on.

Different algorithms may be used in the allocation. It should be noted that the meaning of the “larger amount of stored data” used herein can be related to the particular algorithm adopted. For example, in the second example described above, if an amount of data stored on a processing node is 11 G and an amount of data stored on another processing node is 13 G, when allocation is performed according to the pre-set correspondence relationship between an amount of stored data and a memory capacity, because the amounts of data stored on the two processing nodes are in a same range, that is, 10 G to 20 G, the data amounts can be considered equal and both of the two processing nodes are allocated 200M memory. However, overall, more resources are allocated to a processing unit that stores a larger amount of data to make full use of resources.

In some embodiments, resources allocated to the multiple processing units may be all resources of the resource allocation unit in which the multiple processing nodes are located, or may also be some resources thereof. For example, when resources are allocated to multiple sub-nodes of a distributed database system that are located in a same physical machine or virtual machine, some of the resources possessed by the physical machine or the virtual machine may be reserved for use by other application(s). In that case, only some resources are allocated to the multiple sub-nodes, that is, resource isolation is performed.

In some embodiments, dynamic allocation may be implemented in, but not limited to, the following manners: starting one resource allocation process at a set time interval; starting one resource allocation process when it is detected that the amounts of data stored on the multiple processing units change; or starting one resource allocation process once when it is detected that a change in the amounts of data stored on the multiple processing units exceeds a set threshold.

The specific resource allocation manner may be the same as those used in related art, or as those described above, details of which are not repeated herein.

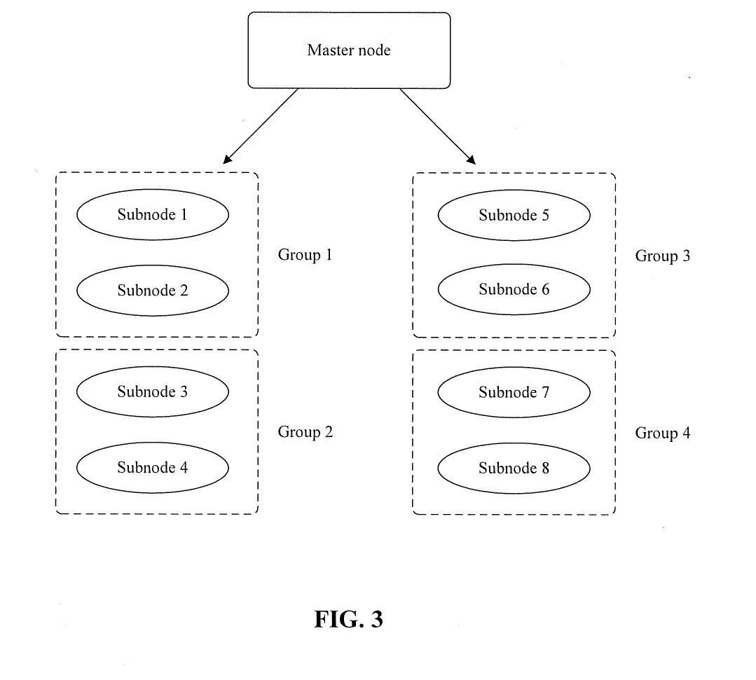

An exemplary implementation process is described below with reference to FIG. 3, which illustrates a distributed database system as an example. The distributed database system includes one master node and multiple sub-nodes. First, all the sub-nodes are grouped. Multiple sub-nodes located in a same physical machine or virtual machine are classified into one group, and as an example, it is assumed here that every two sub-nodes form one group. Each group is allocated fixed shared resources. In this example, when one or more resources are allocated to each sub-node in a group, dynamic allocation is performed according to a proportion of an amount of data stored on the sub-node in a total amount of data stored on all sub-nodes in the group. In some embodiments, allocation adjustment can be made at a predetermined time interval, such as every five minutes. For example, a group includes two nodes/sub-nodes, that is, a node 1 and a node 2, and a resource allocation formula can be:

resources allocated to node 1=allocable resources of the group*(an amount of data stored on node 1/(the amount of data stored on node 1+an amount of data stored on node 2).

By taking memory as an example, assuming that allocable memory of the group is 16 G, the amount of data stored on node 1 is 40 G, and the amount of data stored on node 2 is 60 G, then:

memory allocated to node 1=16 G*(40/(40+60))=6.4 G, and

memory allocated to node 2=16 G*(60/(40+60))=9.6 G.

In some resource allocation scenarios, the values calculated according to the foregoing formulas need to be adjusted according to a minimum resource allocation unit. For example, when a processor resource is represented by the number of kernels, assuming that the number of allocable kernels is 8, then node 1 may be allocated three kernels and node 2 may be allocated five kernels.

Other resources may also be allocated with reference to the above formula, but not all resources need to be allocated in the same manner.

As another example, an exemplary allocation process of the resource temporary disk space is further described as follows:

When a query is run on a sub-node, if operations such as sorting of a large amount of data are involved, large temporary disk space may be required to store intermediate results of the sorting. Specifically, in this example, the temporary disk space is taken as a resource for dynamic allocation. With dynamic allocation of the temporary disk space, a quick response can be made to a requirement for storage space when a storage amount of a sub-node changes, such that the sub-node has sufficient resources to perform corresponding processing.

For example, each group may have two nodes, total storage space is 160 G, node 1 has 40 G data, and node 2 has 60 G data. In this case, allocable temporary disk space in the group is: 160 G−(40 G+60 G)=60 G. Using the foregoing exemplary algorithm, the following allocation may be performed:

temporary disk space allocated to node 1=60 G*(40/(40+60))=24 G, and

temporary disk space allocated to node 2=60 G*(60/(40+60))=36 G.

By means of the foregoing allocation, more temporary disk space is allocated to node 2, which has more data stored thereon. This way, the query that could not be completed due to a shortage of temporary space can be completed, and available resources are fully utilized.

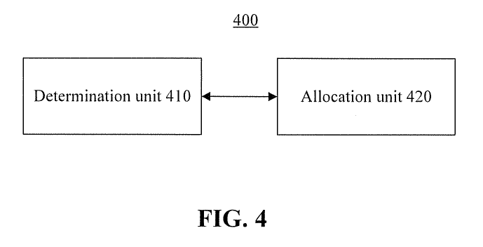

According to some embodiments, resource allocation apparatuses are provided. The resource allocation apparatuses may be used to implement the resource allocation methods described above. In some embodiments, the resource allocation apparatus includes a resource allocation module configured to dynamically allocate resources to multiple processing units that share resources in a same resource allocation unit. As shown in FIG. 4, the resource allocation module 400 can include a determination unit 410 and an allocation unit 420 that are configured to complete resource allocation processing.

For example, determination unit 410 can be configured to determine amounts of data stored on the multiple processing units. Allocation unit 420 can be configured to allocate resources to the multiple processing units according to the amounts of data stored on the multiple processing units, more resources being allocated to a processing unit that stores a larger amount of data.

In some embodiments, the resources allocated by the allocation unit to the multiple processing units may include one or more of the following: memory, processors, network bandwidth, disk transmission bandwidth, and temporary disk space.

In some embodiments, the step of allocating, by allocation unit 420, resources to the multiple processing units according to the amounts of data stored on the multiple processing units may further comprise: the resources allocated to the multiple processing nodes being in direct proportion to the amounts of data stored on the multiple processing units.

In some embodiments, the resource allocation module may further comprise a trigger unit configured to trigger determination unit 410 and allocation unit 420 at a set time interval to start one resource allocation process; trigger, when it is detected that the amounts of data stored on the multiple processing units change, determination unit 410 and allocation unit 420 to start one resource allocation process; or trigger, when it is detected that a change in the amounts of data stored on the multiple processing units exceeds a set threshold, determination unit 410 and allocation unit 420 to start one resource allocation process.

In some embodiments, the multiple processing units in the same resource allocation unit are multiple sub-nodes of a distributed database system that are located in a same physical machine or virtual machine.

For specific implementation of functions of the resource allocation module, reference can be made to corresponding description above, for example, with respect to FIG. 4. Further, each of the units of the resource allocation module may be further configured to perform similar processes as those described above, for example, with respect to FIG. 2.

According to some embodiments of the present application, resource allocation apparatuses are provided. One exemplary resource allocation apparatus includes a memory and a processor:

The memory is configured to store program code.

The processor is configured to execute the program code to cause the resource allocation apparatus to perform the following processing: dynamically allocating resources to multiple processing units that share resources in a same resource allocation unit, wherein one resource allocation process includes: determining amounts of data stored on the multiple processing units; and allocating resources to the multiple processing units according to the amounts of data stored on the multiple processing units, more resources being allocated to a processing unit that stores a larger amount of data.

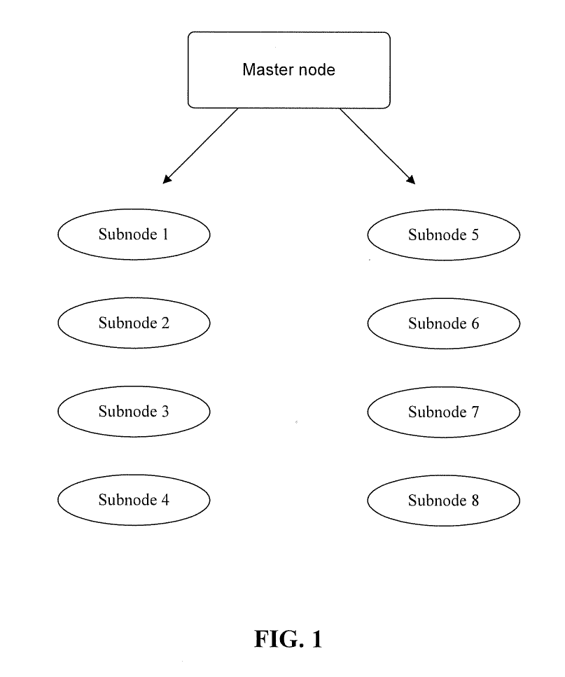

The processor can be configured to execute the program code to perform processes similar to those described above with respect to FIG. 1, details of which are not repeated here.

The sequence numbers of the above examples of the present application are merely for description, and do not imply any preference among the examples. Based on the foregoing description of the implementation manners, a person skilled in the art may clearly understand that the methods of the above embodiments may be implemented by software, hardware, or a combination of software with a hardware platform.

In addition, functional units in the embodiments of the present application may be integrated into one or more processing units, or each of the units may exist alone physically, or two or more units are integrated into one unit. The integrated unit may be implemented in the form of hardware, and/or may be implemented in the form of a software function unit.

The integrated unit implemented in the form of a software functional unit may be stored in a computer-readable storage medium. The software functional unit can be stored in a storage medium, which includes a set of instructions for instructing a computer device (which may be a personal computer, a server, a network device, a mobile device, or the like) or a processor to perform a part of the steps of the methods described in the embodiments of the present application. The foregoing storage medium may include, for example, any medium that can store a program code, such as a USB flash disk, a removable hard disk, a Read-Only Memory (ROM), a Random Access Memory (RAM), a magnetic disk, or an optical disc. The storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The above description is merely some examples of the present application. It is not intended to limit the present application. For those skilled in the art, various modifications and changes may be made to the present application. Any modifications, equivalent replacements, improvements, and the like made within the spirit and principle of the present application shall all fall within the protection scope of the present application.

1. A resource allocation method, for allocating resources to multiple processing units that share resources in a same resource allocation unit, the method comprises:
determining amounts of data stored on the multiple processing units; and
allocating resources to the multiple processing units according to the amounts of data stored on the multiple processing units, a first processing unit being allocated more resources than a second processing unit that stores less amount of data.

2. The method of claim 1, wherein the allocated resources comprise one or more of the following:
memory;
processors;
network bandwidth;
disk transmission bandwidth; and
temporary disk space.

3. The method of claim 1, wherein the resources allocated to the multiple processing units are allocated in approximately a direct proportion to the amounts of data stored on the multiple processing units.

4. The method of claim 1, wherein allocating resources to multiple processing units that share resources in a same resource allocation unit comprises:
starting one resource allocation process at a set time interval; or
starting one resource allocation process based on a determination that one or more amounts of data stored on the multiple processing units change; or
starting one resource allocation process based on a determination that a change in the amounts of data stored on the multiple processing units exceeds a set threshold.

5. The method of claim 1, wherein the multiple processing units in the same resource allocation unit are multiple sub-nodes of a distributed database system that are located in a same physical machine or virtual machine.

6. A resource allocation apparatus, comprising a resource allocation module configured to allocate resources to multiple processing units that share resources in a same resource allocation unit, the resource allocation module comprising:
a determination unit configured to determine amounts of data stored on the multiple processing units; and
an allocation unit configured to allocate resources to the multiple processing units according to the amounts of data stored on the multiple processing units, a first processing unit being allocated more resources than a second processing unit that stores less amount of data.

7. The apparatus of claim 6, wherein the resources allocated by the allocation unit to the multiple processing units comprise one or more of the following:
memory;
processors;
network bandwidth;
disk transmission bandwidth; and
temporary disk space.

8. The apparatus of claim 6, wherein:
the resources allocated to the multiple processing units are allocated in approximately a direct proportion to the amounts of data stored on the multiple processing units.

9. The apparatus of claim 6, wherein the resource allocation module further comprises a trigger unit configured to:
trigger the determination unit and the allocation unit at a set time interval to start one resource allocation process; or
trigger, based on a determination that the amounts of data stored on the multiple processing units change, the determination unit and the allocation unit to start one resource allocation process; or
trigger, based on a determination that a change in the amounts of data stored on the multiple processing units exceeds a set threshold, the determination unit and the allocation unit to start one resource allocation process.

10. The apparatus of claim 6, wherein:
the multiple processing units in the same resource allocation unit are multiple sub-nodes of a distributed database system that are located in a same physical machine or virtual machine.

11. A resource allocation apparatus configured to allocate resources to multiple processing units that share resources in a same resource allocation unit, the resource allocation apparatus comprising:
a memory configured to store program code; and
a processor configured to execute the program code to cause the resource allocation apparatus to:
determine amounts of data stored on the multiple processing units; and
allocate resources to the multiple processing units according to the amounts of data stored on the multiple processing units, a first processing unit being allocated more resources than a second processing unit that stores less amount of data.

12. The apparatus of claim 11, wherein the resources allocated by the resource allocation apparatus comprise one or more of the following:
memory;
processors;
network bandwidth;
disk transmission bandwidth; and
temporary disk space.

13. A non-transitory computer readable medium that stores a set of instructions that is executable by at least one processor of a resource allocation apparatus to perform a method for allocating resources to multiple processing units that share resources in a same resource allocation unit, the method comprises:
determining amounts of data stored on the multiple processing units; and
allocating resources to the multiple processing units according to the amounts of data stored on the multiple processing units, a first processing unit being allocated more resources than a second processing unit that stores less amount of data.

14. The non-transitory computer-readable medium of claim 13, wherein the allocated resources comprise one or more of the following:
memory;
processors;
network bandwidth;
disk transmission bandwidth; and
temporary disk space.

15. The non-transitory computer-readable medium of claim 13, wherein the resources allocated to the multiple processing units are allocated in approximately a direct proportion to the amounts of data stored on the multiple processing units.

16. The non-transitory computer-readable medium of claim 13, wherein allocating resources to multiple processing units that share resources in a same resource allocation unit comprises:
starting one resource allocation process at a set time interval; or
starting one resource allocation process based on a determination that one or more amounts of data stored on the multiple processing units change; or
starting one resource allocation process based on a determination that a change in the amounts of data stored on the multiple processing units exceeds a set threshold.

17. The non-transitory computer-readable medium of claim 13, wherein the multiple processing units in the same resource allocation unit are multiple sub-nodes of a distributed database system that are located in a same physical machine or virtual machine.
